(19) United States
(12) Patent Application Publication
(10) Pub. No.: US 2013/0290346 A1
(43) Pub. Date: Oct. 31, 2013

(54) Geographic Information System (GIS) with Linked GIS Objects and GIS Operation

(71) Applicant: Hsin-Chih Liao, Mill Creek, WA (US)

(72) Inventor: Hsin-Chih Liao, Mill Creek, WA (US)

(21) Appl. No.: 13/872,602

(22) Filed: Apr. 29, 2013

Related U.S. Application Data
(60) Provisional application No. 61/639,425, filed on Apr. 27, 2012.

(51) Int. Cl. G06F 17/30

(52) U.S. Cl. CPC G06F 17/30241
USPC 707/743

(57) ABSTRACT

A geographic information system (GIS) includes a created link between GIS objects in the database of the geographic information system (GIS), and performed GIS operations. The linked GIS object and performed GIS operation provides a mechanism to more easily identify the impact of making an update to a GIS database. A database association is maintained between GIS object identifiers and the requesting GIS operation to enable a reverse trace back from the nature of the GIS operation to the GIS object involved.

The present application claims priority from U.S. Provisional No. 61/639,425 entitled “Geographic Information System (GIS) With Linked GIS Objects and GIS Operation”, filed Apr. 27, 2012, the entirety of which is expressly incorporated herein by reference.

### BACKGROUND OF THE INVENTION

1. Field of the Invention

This invention relates generally to public safety systems, geographic information system (GIS), location based systems (LBS), and wireless subscriber information.

2. Background of Related Art

Wireless devices, and in particular cell phones, have become ubiquitous with day-to-day life. A majority of people in the United States now own cell phones. Location services are a more recent advanced feature made available for use with wireless devices, perhaps most notably to provide location of a cell phone. The general goal of location-based services is to automatically provide location-based information to a requesting application. The requesting application may be operating on the wireless device itself, or even on an external application running, e.g., on another device in the wireless or other network. Some exemplary applications that use location services include mapping applications that show interesting places in a vicinity of the wireless device's current global position. Location based services are available for wireless devices such as personal digital assistants (PDAs) as well as for cell phones.

A geographic information system (GIS) captures, stores, manipulates, analyzes, and manages various forms of geographical data. A geographic information system is typically custom designed for the needs of a particular application.

GIS data represents real objects such as roads, land use, elevations, bodies of water, etc. Real objects may be discrete objects (e.g., a building) or continuous fields (e.g., rainfall amount or elevation). As technology advances, GIS data becomes more and more visually realistic, more recently venturing into 3D data. Most often the geographical data is obtained from digitized map data. As appreciated by the present inventor, map data (and geographical data in general) is subject to change, for instance, as roads are built, as points of interest are added or demolished, etc.

Geocoding refers to the interpolation of a spatial coordinate location from a street address or the like. Reverse geocoding refers to the opposite; that is to returning an estimate of a specific street address as it relates to a given spatial coordinate.

Global information systems have application in location based services. For instance, GIS permits a mobile device to display its location in relation to a fixed point of interest (gas station, store, etc.) or other geographically defined location (e.g., a fire hydrant)

The database for conventional geographic information systems is updated via brute force, i.e., whenever a GIS database is updated, all previous validations and computations against the GIS database must be re-run to ensure its validity. The inventor hereof recognized that the conventional mechanism to update a geographic information system (GIS) database is time consuming, creates the potential of unnecessary re-validation, and leaves a certain amount of uncertainty of the validity of the prior GIS operation result.

### SUMMARY OF THE INVENTION

In accordance with the principles of the present invention, a method of assessing an impact of an update to a geographic information system (GIS) database comprises logging a received GIS operation request relating to a given geographic information system database. A list of GIS object identifiers returned with a result of said GIS operation request is stored. In this way a link between the GIS object identifiers and performed GIS operations provides a mechanism to identify an impact of making an update to the GIS database.

A method of assessing an impact of an update to a geographic information system (GIS) database in accordance with another aspect of the invention comprises logging in a database a link between a given geographical information system (GIS) object in a GIS database, and a GIS operation performed against the given GIS object. In this way the linked GIS object and performed GIS operation provides a mechanism to identify an impact of making an update to the GIS database.

In accordance with yet another aspect of the invention, a method of assessing an impact of an update to a geographic information system (GIS) database comprises maintaining a database of an association between a plurality of GIS object identifiers and requested GIS operations against each of a corresponding plurality of GIS objects. The associated plurality of GIS object identifiers and requested GIS operations provides a mechanism to identify an impact of making an update to a GIS database.

### BRIEF DESCRIPTION OF THE DRAWINGS

Features and advantages of the present invention will become apparent to those skilled in the art from the following description with reference to the drawings, in which:

FIG. 1 shows an exemplary GIS system request from a requesting system, and the resulting response returned to the requesting system, in accordance with the principles of the present invention.

FIG. 2 shows exemplary initial ‘linking’ message flow (step 1) wherein a GIS operation is performed, and the specific GIS object IDs that were involved in the GIS operation are stored, yielding a result in the GIS, in accordance with the principles of the present invention.

FIG. 3 shows exemplary message flow of step 2 wherein a GIS Update occurs in a GIS system that has the capability of storing the delta changes, in accordance with the principles of the present invention.

FIG. 4 shows exemplary message flow of step 3 wherein the impact is determined, and only the GIS operation that were affected by a GIS system change need be re-submitted, in accordance with the principles of the present invention.

### DETAILED DESCRIPTION OF ILLUSTRATIVE EMBODIMENTS

The present invention provides a created link between objects in the database of the geographic information system (GIS), and performed GIS operations. The linked GIS object and performed GIS operation provides a mechanism to more easily identify the impact of making an update to a GIS database.

Thus, in accordance with the principles of the present invention, an association between GIS object identifiers and the requesting GIS operation allows a reverse trace back (from the nature of the GIS operation) to the GIS object involved. The invention also provides a new and very useful way to finding errors in the data associated within GIS object.

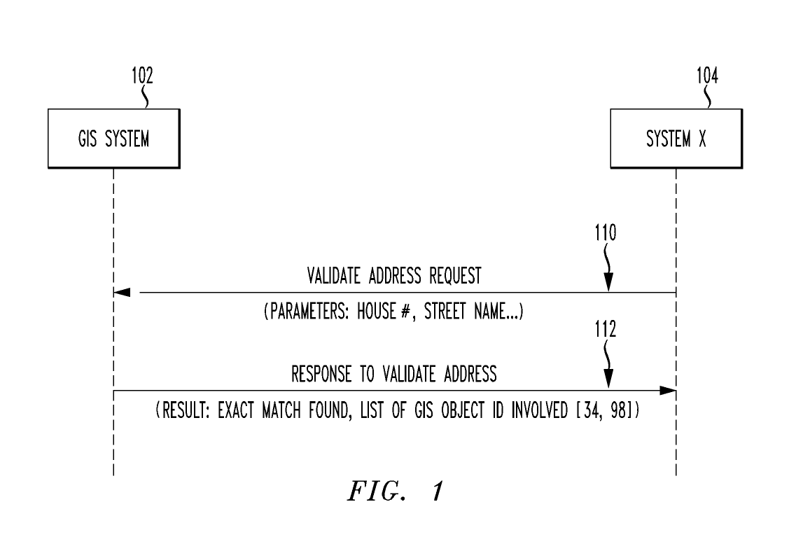

FIG. 1 shows an exemplary GIS system request from a requesting system, and the resulting response returned to the requesting system, in accordance with the principles of the present invention.

A geographic information system (GIS) 102 as used herein (a system that uses a GIS database) refers to a system that accepts a GIS related request and performs computation using the GIS data within a GIS database. “System X” (requestor) 104 as used herein refers to any system that is capable of sending a GIS request and receiving the corresponding response.

In accordance with the present invention, when a GIS database that is used by the GIS system 102 gets updated, System X 104 can perform a ‘smart’ re-validation instead of a brute-force re-validation of all previous GIS operations as is conventionally performed.

In accordance with the principles of the present invention, the requestor 104 of a GIS operation against a GIS database receives and stores the unique identifier(s) of the GIS object(s) (Boundary, Centerline, Address Point, etc.) involved in reaching the outcome of the GIS operation. This “association” of the GIS object ID to operation (or the entity behind the scene that triggered the GIS operation) are used to assess the impact of future update to the data within the GIS database.

A GIS operation (routability, validation, etc) against a GIS database yields a result that involves usage of specific GIS object(s). Each of these GIS objects (Boundary, Centerline, Address Point, etc.) has a unique identifier associated with them. (NOTE: uniqueness of the GIS object can be a composition of multiple attribute within a GIS object.)

As part of any GIS operation, the identifier(s) of the involved GIS object(s) are returned to the requestor of the GIS operation as part of the result. The requestor of the GIS operation stores the GIS object identifiers with the operational result (or stored with the underlying entity that triggered the GIS operation).

When GIS database is updated, a delta of the affected GIS object(s) is identified. This delta is further used to generate a list of unique identifiers associated with the delta GIS objects. Information within the list of unique identifiers (of GIS objects) is made available to inform all users/requestors of the GIS database.

The recipient of the delta GIS object identifiers list can do further processing of the information and find out which prior GIS operation(s) (or underlying entity) are impacted (since the GIS object identifiers was previously stored) and take appropriate action on those prior operation/result.

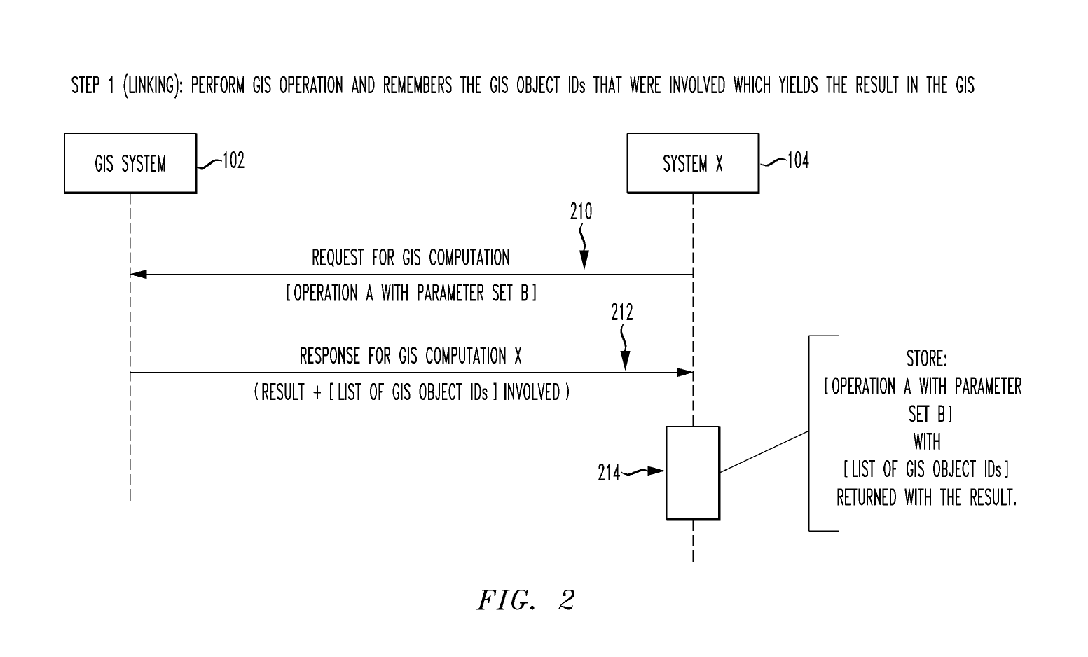

FIG. 2 shows exemplary initial ‘linking’ message flow (step 1) wherein a GIS operation is performed, and the specific GIS object IDs that were involved in the GIS operation are stored, yielding a result in the GIS, in accordance with the principles of the present invention.

In particular, as shown in step 210 of FIG. 2, the System X 104 sends a request to the GIS system 102 requesting that ‘operation A’ be performed with parameter set B.

In step 212, the GIS System 102 performs operation A with parameter set B using data within the GIS database, yields a result. A list of GIS object IDs involved as part of arriving at the result are returned from the GIS System 102 to the requestor (System X) 104, along with the result of the requested operation.

In step 214, the requestor (e.g., System X) 104 receives the response 212 for its request 210, and stores either: (1) The nature of the request (i.e. [Operation A with parameter set B]); or (2) The result of the request with the List of GIS object IDs return. NOTE: the decision of whether (1) or (2) is stored depends on the usefulness on the particular re-validation needs. FIG. 2 shows storage of decision (1).

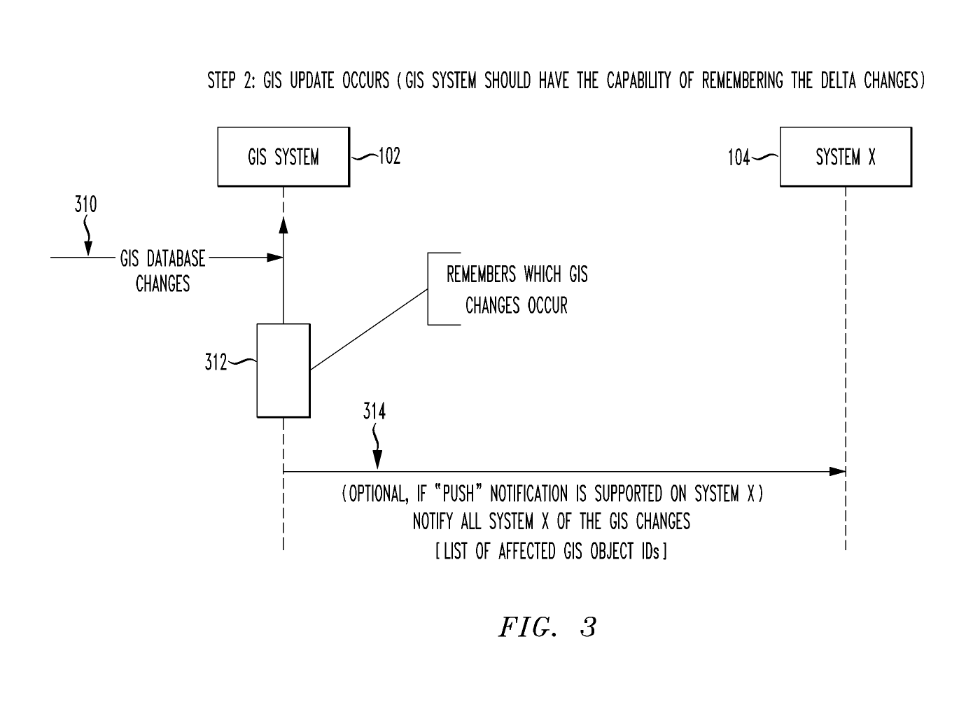

FIG. 3 shows exemplary message flow (step 2) wherein a GIS Update occurs in a GIS system that has the capability of storing the delta changes, in accordance with the principles of the present invention.

In particular, as shown in step 310 of FIG. 3, changes to the GIS database in the GIS system 102 are received by the GIS system 102. Changes can be, e.g., in the form of an update of a GIS update, a deletion of a GIS object, insertion of a GIS object, etc. A full list of changes that can happen on a GIS object is outside of the scope of this document. The point is that information about the change that occurred to any given GIS object is linked to that GIS object.

In step 312, the GIS System 102 keeps track of which GIS object(s) were changed. The purpose of this step 312 is to discover the change, or delta, of changes to GIS objects at a later phase.

Step 314 is optional. In optional step 314, if the requestor (System X) 104 is capable of accepting a push notification of changes to GIS objects, then the GIS system 102 can push a list of GIS object IDs that were changed as part of step 310.

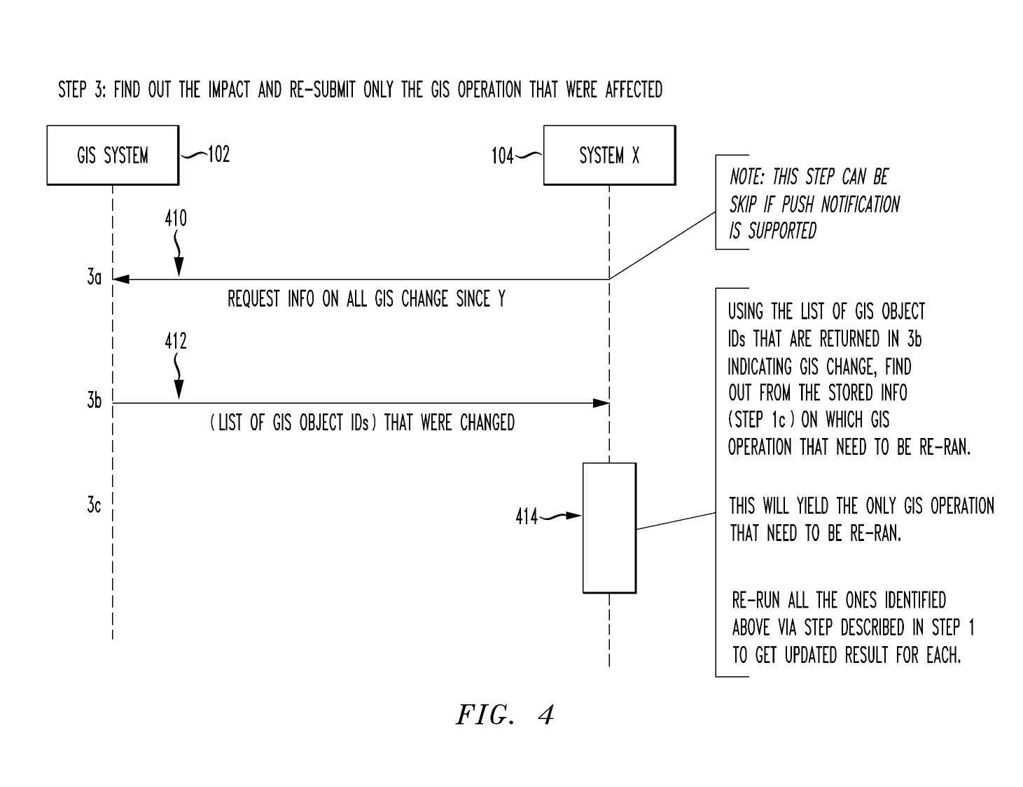

FIG. 4 shows exemplary message flow (step 3) wherein the impact of a change to the GIS database is determined, and only the GIS operations that were affected by a GIS system change need be re-submitted, in accordance with the principles of the present invention.

In particular, as shown in step 410 of FIG. 4, the System X 104 queries the GIS system 102 to get a list of changes to GIS objects that have occurred since a given parameter “Y”, where “Y” can be a search criteria supported by the specific GIS system 102.

NOTE: if push notification is supported in step 314 of FIG. 3, then step 410 and the response associated therewith is not required.

In step 412, the GIS system 102 returns a list of GIS object IDs that changed, that matched criteria ‘Y’ provided in step 410.

In step 414, from the result of step 412 (or step 314 if push notification is supported), it is determined what previous GIS operation(s)/result(s) were impacted by querying the stored information in step 214. This yields a list of GIS operation(s) that have been previous run, that now need to be re-run. Thus, for every identified affected GIS operation, that GIS operation is efficiently re-run via information described in “Step 1”, to get updated results.

While the invention has been described with reference to the exemplary embodiments thereof, those skilled in the art will be able to make various modifications to the described embodiments of the invention without departing from the true spirit and scope of the invention.

What is claimed is:

1. A method of assessing an impact of an update to a geographic information system (GIS) database, comprising:
logging a received GIS operation request relating to a given geographic information system database; and
storing a list of GIS object identifiers returned with a result of said GIS operation request
wherein a link between said GIS object identifiers and performed GIS operations provides a mechanism to identify an impact of making an update to said GIS database.

2. A method of assessing an impact of an update to a geographic information system (GIS) database according to claim 1, further comprising:
performing a reverse trace back from said logged link between said GIS object identifiers, and requested GIS operations thereon.

3. A method of assessing an impact of an update to a geographic information system (GIS) database, comprising:
logging in a database a link between a given geographical information system (GIS) object in a GIS database, and a GIS operation performed against said given GIS object;
wherein said linked GIS object and performed GIS operation provides a mechanism to identify an impact of making an update to said GIS database.

4. A method of assessing an impact of an update to a geographic information system (GIS) database according to claim 3, further comprising:
performing a reverse trace back from said logged link between said GIS objects, and performed GIS operations thereon.

5. A method of assessing an impact of an update to a geographic information system (GIS) database, comprising:
maintaining a database of an association between a plurality of GIS object identifiers and requested GIS operations against each of a corresponding plurality of GIS objects;
wherein said associated plurality of GIS object identifiers and requested GIS operations provides a mechanism to identify an impact of making an update to a GIS database.

6. A method of assessing an impact of an update to a geographic information system (GIS) database according to claim 5, further comprising:
performing a reverse trace back from said maintained association between said GIS object identifiers, and requested GIS operations thereagainst.
